(19) United States
(12) Patent Application Publication
(10) Pub. No.: US 2005/0243460 A1
(43) Pub. Date: Nov. 3, 2005

(54) Disk device

(75) Inventors: Takahiro Asano, Ome-shi (JP); Toshikuni Sato, Fussa-shi (JP); Jun Shimizu, Ome-shi (JP); Hideyuki Miyazaki, Ome-shi (JP); Takeshi Okutomi, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/109,828

(22) Filed: Apr. 20, 2005

(30) Foreign Application Priority Data
Apr. 30, 2004 (JP) 2004-136772

(51) Int. Cl. G11B 17/00

(52) U.S. Cl. 360/97.01

(57) ABSTRACT

A case has a central axis C and first and second regions situated individually on the opposite sides of the central axis. Provided in the case are a recording medium, a drive motor which supports and rotates the recording medium, a head, a carriage which supports the head for movement, and a latch mechanism. The recording medium is located so as to be eccentric to the central axis on the side of the first region, and the latch mechanism is located in the second region. The head actuator has a bearing portion provided in the second region, an arm extending from the bearing portion into the first region, a suspension extending from the arm, located in the first region, and supporting the head, and a driver which is located in the second region and rotates the arm.

### CROSS-REFERENCE TO RELATED APPLICATIONS

This application is based upon and claims the benefit of priority from prior Japanese Patent Application No. 2004-136772, filed Apr. 30, 2004, the entire contents of which are incorporated herein by reference.

### BACKGROUND OF THE INVENTION

1. Field of the Invention

This invention relates to a disk device having a disk for use as a recording medium.

2. Description of the Related Art

In recent years, disk devices, such as magnetic disk devices, optical disk devices, etc., have been widely used as external recording devices of computers and image recording devices.

A magnetic disk device as an example of a disk device generally has a case in the form of a rectangular box. The case contains magnetic disks for use as magnetic recording media, a spindle motor, magnetic heads, and a head actuator. The spindle motor serves as drive means that supports and rotates the disks. The magnetic heads are used to write and read information to and from the disks. The head actuator supports the magnetic heads for movement with respect to the magnetic disks. Further, the case contains a voice coil motor, a substrate unit, etc. The voice coil motor rocks and positions the head actuator. The substrate unit has a head IC and the like.

A printed circuit board for controlling the respective operations of the spindle motor, voice coil motor, and magnetic heads through the substrate unit is screwed to the outer surface of the case. An interface (I/F) connector for connecting the magnetic disk device to an external device is soldered to an end portion of the circuit board.

According to Jpn. Pat. Appln. KOKAI Publication No. 2000-210058, for example, there is provided a thin card-shaped magnetic disk device that can be loaded into a card slot of, e.g., a personal computer. The card-shaped disk device of this type, compared with a conventional magnetic disk device, must be made thinner and smaller. To attain this, various components are mounted on a plate-shaped base, a support frame is fixed along the peripheral edge of the base, and a plate-shaped top cover is attached to the support frame. A printed circuit board is provided on the reverse side of the base, and an I/F connector on the circuit board is positioned and held by a dedicated fixing member on the support frame.

Recently, magnetic disk devices have been further reduced in size to be suitably used as recording devices of various electronic apparatuses, especially smaller-sized ones. In miniaturizing the magnetic disk devices, however, their basic components cannot be reduced in number, so that it is hard to secure a satisfactory installation space over a small-sized base. Usually, a printed circuit board and electronic components in a magnetic disk device are connected electrically to one another by using stacking connectors or the like. However, these connectors are relatively tall, so that they constitute a hindrance to a reduction in thickness of the entire magnetic disk device including the circuit board.

### BRIEF SUMMARY OF THE INVENTION

According to an aspect of the invention, there is provided a disk device comprising: a case in the form of a rectangular box having a central axis and first and second regions situated individually on the opposite sides of the central axis; a disk-shaped recording medium located in the case so as to be eccentric to the central axis on the first region side; a drive motor which is located in the case and supports and rotates the recording medium; a head which processes information for the recording medium; a head actuator which is provided in the case, supports the head for movement, and moves the head with respect to the recording medium; and a latch mechanism which is provided in the second region and latches the head actuator in a shunt position. The head actuator has a bearing portion provided in the second region, an arm extending from the bearing portion into the first region, a suspension which extends from the arm, is situated in the first region, and supports the head, and a driver which is located in the second region and rotates the arm.

According to another aspect of the invention, there is provided a disk device comprising: a case in the form of a rectangular box; a disk-shaped recording medium located in the case; a drive motor which is located in the case and supports and rotates the recording medium; a head which processes information for the recording medium; a head actuator which is provided in the case, supports the head for movement, and moves the head with respect to the recording medium; a control circuit board overlapped on an outer surface of the case; a first connector mounted on the control circuit board; and a second connector connected to the first connector and the drive motor. The case has a storage recess which opens in the outer surface of the case, projects into the case, and houses the first and second connectors.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a hard disk drive (hereinafter referred to as an HDD) according to a first embodiment of the invention;

FIG. 2 is an exploded perspective view of the HDD;

FIG. 3 is an exploded perspective view showing a case and the internal structure of the HDD;

FIG. 4 is a perspective view showing the control circuit board side of the HDD;

FIG. 5 is a sectional view showing the case and the control circuit board side of the HDD; and

FIG. 6 is a sectional view of the HDD taken along line VI-VI of FIG. 1.

### DETAILED DESCRIPTION OF THE INVENTION

An embodiment in which this invention is applied to an HDD will now be described in detail with reference to the accompanying drawings.

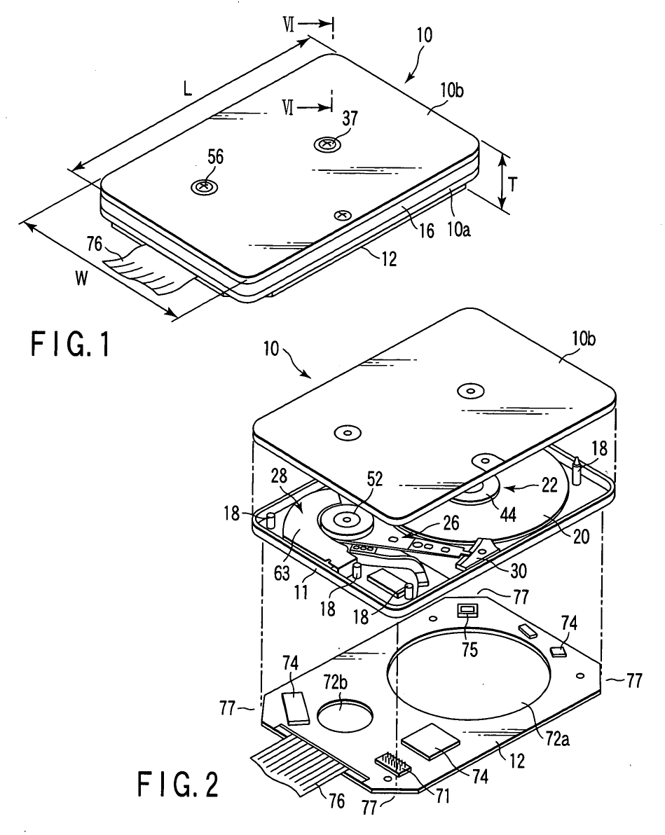

As shown in FIGS. 1 and 2, the HDD comprises a case 10 in the form of a substantially rectangular box and a control circuit board 12. The case 10 contains various members, which will be described later. The circuit board 12 is lapped on the outer surface of the case 10. The case 10 and the circuit board 12 each have a length L of about 32 mm and a width W of about 24 mm. When the two are joined together, a resulting structure has a thickness T of about 3.3 mm.

The case 10, which constitutes a body of the HDD, comprises a first shell 10a and a second shell 10b having substantially equal dimensions. The first and second shells 10a and 10b are substantially rectangular metallic structures, which have sidewalls set up on their respective peripheral edge portions. The shells 10a and 10b are arranged facing each other with their peripheral edge portions opposed. A belt-shaped seal member 16 is wound around the peripheral edge portions of the shells 10a and 10b. The seal member connects the peripheral edge portions of the shells and seals a gap between them. Thus, the case 10 is formed having the shape of a rectangular box.

The bottom surface of the first shell 10a forms a rectangular mounting surface 11. Four corners of the case 10, including the corners of the mounting surface 11, are rounded in a circular arc. Thus, the seal member 16 that is wound around the peripheral edge portion of the case 10 is prevented from being damaged by the corners of the case, and airtightness is prevented from being worsened by lifting of the seal member.

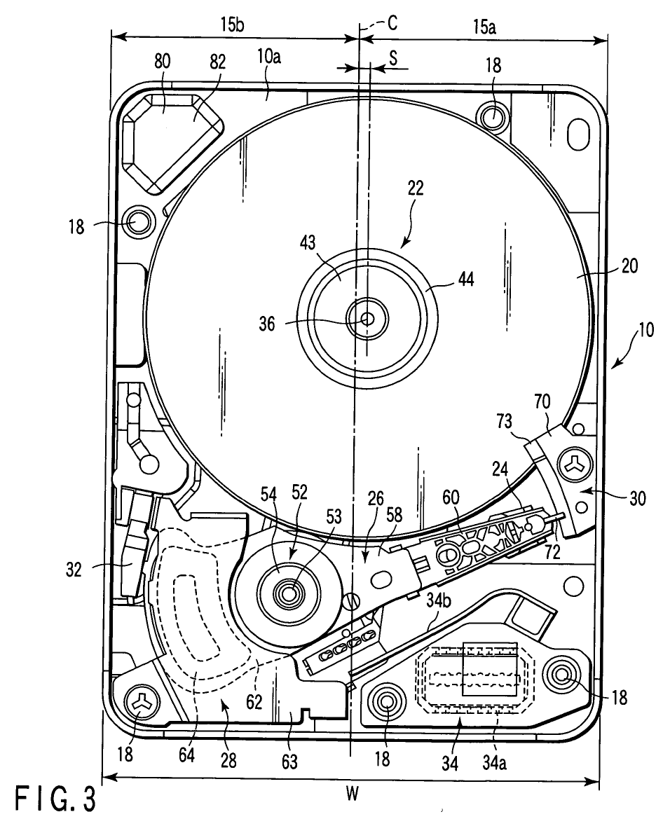

As shown in FIGS. 2 and 3, the case 10 has a first region 15a and a second region 15b that are situated individually on the opposite sides of a central axis C extending in its longitudinal direction. In the case 10, a plurality of support posts 18 are provided on the peripheral edge portion of the case. Each support post 18 has a proximal end that is fixed to the inner surface of the first shell 10a by an elastic member of rubber or the like. It is set substantially upright on the inner surface of the first shell 10a. Corresponding to each support post 18 in position, a tapped hole is formed in the mounting surface 11 and extends into the post.

The case 10 contains a magnetic disk 20 of, e.g., 0.85 inch, for use as an information recording medium, a spindle motor 22, a magnetic head 24, and a carriage 26. The spindle motor 22 serves as a drive motor that supports and rotates the disk. The magnetic head 24 is used to write and read information to and from the disk 20. The carriage 26 supports the magnetic head 24 for movement with respect to the magnetic disk 20. Further, the case 10 contains a voice coil motor (hereinafter referred to as a VCM) 28, a ramp load mechanism 30, a solenoid latch 32, a substrate unit 34, etc. The VCM 28 rotates and positions the carriage 26. The ramp load mechanism 30 holds the magnetic head 24 in a position off the magnetic disk 20 when the head is moved to the peripheral edge portion of the disk. The solenoid latch 32 holds the carriage 26 in a shunt position. The substrate unit 34 has a head IC and the like.

The spindle motor 22 is mounted on the first shell 10a. The motor 22 has a pivot 36, which is fixed to the inner surface of the first shell 10a and set substantially upright on it. An extended end of the pivot 36 is screwed to the second shell 10b by a fixing screw 37 that is externally screwed into the second shell. Thus, the pivot 36 is dually supported by the first and second shells 10a and 10b.

A rotor is rotatably supported on the pivot 36 by a bearing (not shown). An end portion of the rotor on the side of the second shell 10b constitutes a columnar hub 43, on which the magnetic disk 20 is fitted coaxially. An annular clamp ring 44 is fitted on an end portion of the hub 43, thereby holding the inner circumferential edge portion of the disk 20. Thus, the disk 20 is fixed to the rotor and supported for rotation integral with the rotor.

An annular permanent magnet (not shown) is fixed to an end portion of the rotor on the side of the first shell 10a and situated coaxially with the rotor. The spindle motor 22 has a stator core attached to the first shell 10a and coils wound on the stator core. The stator core and the coils are arranged across a gap outside the permanent magnet.

As shown in FIG. 3, the center of the pivot 36 of the spindle motor 22 and that of the magnetic disk 20 are situated in the first region 15a and deviated from the central axis C of the case 10 by an eccentric distance S. The motor 22 and the disk 20 are slightly shifted to the side of the first region 15a with respect to the central axis C. The eccentric distance S is adjusted to 5 to 6% of the width W of the case 10, e.g., to about 1.2 mm in this case.

The carriage 26 that constitutes a head actuator comprises a bearing assembly 52 that is fixed on the inner surface of the first shell 10a in the second region 15b. The bearing assembly 52 that serves as a bearing portion has a pivot 53 and a cylindrical hub 54. The pivot 53 is set upright on the inner surface of the first shell 10a. The hub 54 is rotatably supported on the pivot 53 by a pair of bearings. An extended end of the pivot 53 is screwed to the second shell 10b by a fixing screw 56 that is externally screwed into the second shell. Thus, the pivot 53 is dually supported by the first and second shells 10a and 10b.

The carriage 26 comprises an arm 58, a suspension 60, and a support frame 62. The arm 58 extends on the side of the first region 15a from the hub 54. The suspension 60 is an elongate plate that extends from the distal end of the arm 58. The support frame 62 extends from the hub 54 on the side opposite from the arm 58. The magnetic head 24 is supported on an extended end of the suspension 60 by a gimbals portion (not shown). The suspension 60 and the head 24 are situated in the first region 15a. The head 24 is subjected to a given head load toward the surface of the magnetic disk 20 by a spring force of the suspension 60. A voice coil 64 that constitutes the VCM 28 is fixed integrally to the support frame 62 and situated in the second region 15b.

The VCM 28, which serves as a driver for rotating the carriage 26 around the bearing assembly 52, comprises a pair of yokes 63 and a magnet (not shown). In the second region 15b, the yokes 63 are fixed on the first shell 10a and opposed to each other with a gap between them. The magnet is fixed to the inner surface of one of the yokes and opposed to the voice coil 64. When the voice coil 64 is energized, the carriage 26 rotates over the magnetic disk 20 between the shunt position shown in FIG. 3 and a position on the surface of the disk. The magnetic head 24 is positioned on a desired track of the magnetic disk 20.

The solenoid latch 32 that serves as a latch mechanism is provided on the first shell 10a in the second region 15b and situated on the opposite side of the yokes 63 with respect to the bearing assembly 52. If the HDD is subjected to any external force, such as a shock, the latch 32 latches the carriage 26 that is moved to the shunt position, thereby preventing the carriage from moving from the shunt position to an operating position.

The ramp load mechanism 30 is fixed to the inner surface of the first shell 10a in the first region 15a. It comprises a ramp member 70 and a tab 72. The ramp member 70 is fixed to the inner surface of the first shell 10a in the first region 15a and situated opposite the peripheral edge portion of the magnetic disk 20. The tab 72 extends from the distal end of the suspension 60 and serves as an engaging member. The ramp member 70 has a ramp surface 72 that can be engaged by the tab 72. When the carriage 26 rotates from the inner peripheral portion of the disk 20 to the shunt position outside the disk, the tab 72 engages the ramp surface 73 of the ramp member 70. Thereafter, the tab 72 is pulled up along a slope of the ramp surface to unload the magnetic head 24. When the carriage 26 rotates to the shunt position, the tab 72 is supported on the ramp surface 73 of the ramp member 70. Thereupon, the magnetic head 24 is kept off the surface of the magnetic disk 20.

The substrate unit 34 has a body 34a that is formed of a flexible printed circuit board. The body 34a is fixed to the inner surface of the first shell 10a in the first region 15a. Electronic components, such as the head IC, head amplifier, etc., are mounted on the body 34a. The substrate unit 34 has a main flexible printed circuit board (hereinafter referred to as a main FPC) 34b that extends from the body 34a. An extended end of the main FPC 34b is connected to that part of the carriage 26 which is situated near the bearing assembly 52. Further, the extended end is connected electrically to the magnetic head 24 by a cable (not shown) that is located on the arm 58 and the suspension 60. A connector (not shown) for connection with the control circuit board 12 is mounted on the bottom surface of the body of the substrate unit 34. This connector is exposed to the mounting surface 11 of the first shell 10a through an opening in the first shell.

In the second region 15b of the case 10, as shown in FIGS. 3, 5 and 6, a storage recess 80 for storing a connector (mentioned later) is formed in one corner portion of the first shell 10a, that is, the corner portion situated on the side opposite from that corner portion in which the VCM 28 is located. An opening 81 is formed in the mounting surface 11 of the first shell 10a, and a cup-shaped shielding member 82 is fitted into the opening from outside the first shell and projects into the case 10. The shielding member 82 defines the storage recess 80 that opens in the mounting surface 11 of the case 10 and projects into the case. Alternatively, the shielding member 82 may be formed integrally with the first shell 10a.

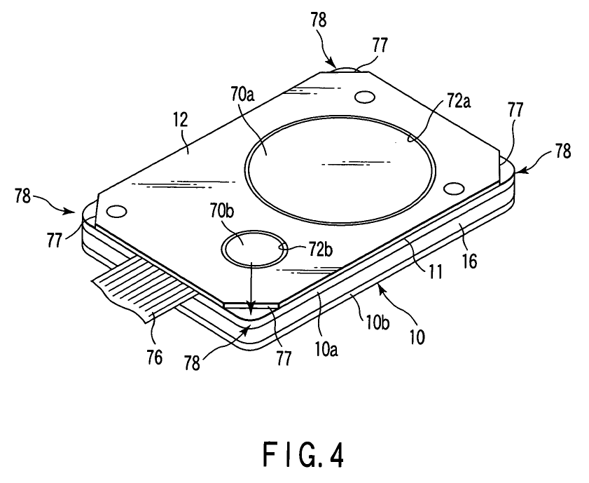

As shown in FIGS. 2 to 6, the control circuit board 12, a printed circuit board, is a rectangular structure that is substantially equal to the mounting surface 11 of the case 10 in length and width. The mounting surface 11 of the case 10 is formed having circular protrusions 70a and 70b that correspond to the spindle motor 22 and the bearing assembly 52, respectively. The control circuit board 12 is formed having circular openings 72a and 72b that correspond to the protrusions 70a and 70b, respectively. A plurality of electronic components 74 and connectors 71 and 75 are mounted on the control circuit board 12. The connector 75, which serves as a first connector, is formed of a stacking connector and situated opposite the storage recess 80 of the case 10.

A flexible printed circuit board 76 for electrical connection between the HDD and an external device is connected to the control circuit board 12. It is drawn out through one short side of the circuit board 12, and a plurality of connector terminals are formed on its extended end. Further, four corner portions of the control circuit board 12 are cut obliquely, e.g., at an angle of 45 degrees to each side, and individually form notch portions 77.

The control circuit board 12, formed in this manner, is overlapped on the mounting surface 11 of the case 10 and screwed the first shell 10a with screws. The circuit board 12 is located with its four sides aligned or coincident individually with four sides of the mounting surface 11. The protrusions 70a and 70b in the mounting surface 11 are located in the openings 72a and 72b, respectively, of the circuit board 12. The connector 71 on the circuit board 12 is connected to the connector on the substrate unit 34.

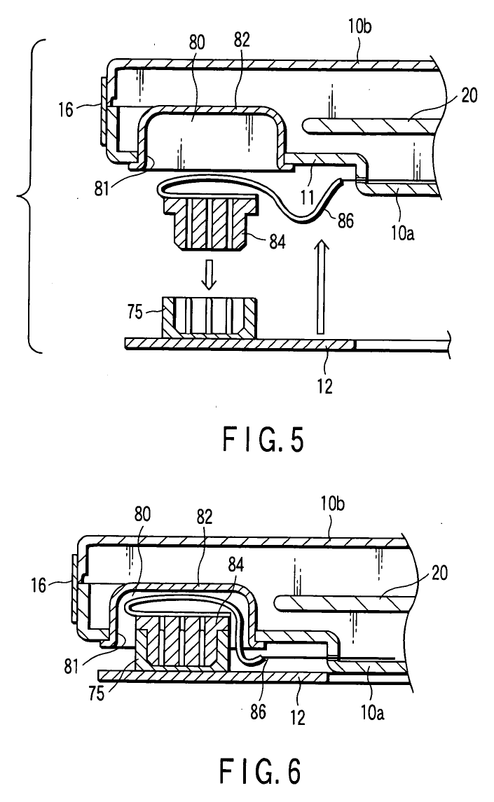

A connector 84 that serves as a second connector is connected to the connector 75 from above. The connector 84 is connected electrically to the spindle motor 22 through a flexible printed circuit board 86. When the control circuit board 12 is put on the mounting surface 11, as shown in FIG. 6, the connectors 75 and 84 are located in the storage recess 80 of the case 10.

The notch portions 77 at the four corner portions of the control circuit board 12 are situated corresponding individually to the four corner portions of the mounting surface 11. Thus, the four corner portions of the mounting surface 11 are exposed to the outside without being covered by the circuit board 12. The corner portions of the case 10, including the four exposed corner portions of the mounting surface 11, individually constitute retaining portions 78 for holding the case without contact with the circuit board 12.

According to the HDD constructed in this manner, the center of the magnetic disk 20 is located in the first region 15a of the case 10 and at the eccentric distance S from the central axis C. In other words, the disk 20 and the spindle motor 22 are slightly shifted to the side of the first region 15a with respect to the central axis C of the case 10. In consequence, the second region 15b of the case 10, compared with the first region 15a, can ensure a wider installation space for components than the first region 15a can. Since the VCM 28 and the solenoid latch 32 that have relatively wide areas are located in the second region 15b, the individual components can be arranged efficiently in the case 10. At the same time, the yokes 63 and the permanent magnet of the VCM 28 can be large-sized. Thus, the available HDD can be further reduced in size.

The case 10 has the storage recess 80 that opens in the mounting surface 11, and the connector 75 mounted on the control circuit board 12 and the connector 84 connected to it are arranged in the recess 80. Although the relatively high connector 75 is provided on the circuit board 12, therefore, its height can be absorbed by the recess 80, so that the entire HDD, including the circuit board, can be reduced in thickness. Thus, a more small-sized HDD can be obtained.

The first and second shells 10a and 10b that constitute the case 10 are supported opposite to each other with a given gap between them by the support posts 18 that are set up on one of the shells. If any external force acts on the case 10, therefore, the case and the components therein can be prevented from being damaged. Since the proximal end of each support post 18 is fixed to the shell by the elastic member, a shock can be absorbed, and errors in dimensions and assembly between the first and second shells 10a and 10b can be also absorbed. With use of the support posts 18, moreover, screwed portions between the shells 10a and 10b can be reduced in number, and assemblability and maintainability can be improved.

The card-shaped portable HDD constructed in this manner can be used as a recording device for various electronic apparatuses, such as a cellular telephone, digital camera, video camera, personal digital assistant (PDA), etc.

The present invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

For example, the number of the magnetic disk in the HDD is not limited to one and may be increased as required. The size of the magnetic disk used is not limited to 0.85 inch and may alternatively be 1.8 or 2.5 inches. Further, the control circuit board may be provided with a connector, in place of a connection cable, for connection with an external device.

1. A disk device comprising:
a case in the form of a rectangular box having a central axis and first and second regions situated individually on the opposite sides of the central axis;
a disk-shaped recording medium located in the case so as to be eccentric to the central axis on the first region side;
a drive motor which is located in the case and supports and rotates the recording medium;
a head which processes information for the recording medium;
a head actuator which is provided in the case, supports the head for movement, and moves the head with respect to the recording medium; and
a latch mechanism which is provided in the second region and latches the head actuator in a shunt position,
the head actuator having a bearing portion provided in the second region, an arm extending from the bearing portion into the first region, a suspension which extends from the arm, is situated in the first region, and supports the head, and a driver which is located in the second region and rotates the arm.

2. The disk device according to claim 1, wherein the head actuator has a support frame extending from the bearing portion in a direction opposite from the arm, and the driver comprises a voice coil attached to the support frame, and a yoke located in the second region and situated opposite the voice coil.

3. The disk device according to claim 1, which further comprises a ramp load mechanism which is located near a peripheral edge portion of the recording medium in the first region and holds the head in a position off the recording medium.

4. The disk device according to claim 1, which further comprises a substrate unit located in the first region and connected electrically to the head.

5. The disk device according to claim 1, wherein S is adjusted to 5 to 6% of W where W is a width of the case in a direction perpendicular to the central axis and S is an eccentric distance between the recording medium and the central axis.

6. The disk device according to claim 1, which further comprises a control circuit board overlapped on an outer surface of the case, a first connector mounted on the control circuit board, and a second connector connected to the first connector and the drive motor, and wherein the case has a storage recess which opens in the outer surface of the case, projects into the case, and houses the first and second connectors.

7. The disk device according to claim 6, wherein the storage recess is provided in a corner portion of the case in the second region.

8. The disk device according to claim 1, wherein the case is formed having a longitudinal dimension of about 32 mm and a transverse dimension of about 24 mm.

9. The disk device according to claim 1, wherein the recording medium is formed having a diameter of 0.85 inch.

10. A disk device comprising:
a case in the form of a rectangular box;
a disk-shaped recording medium located in the case;
a drive motor which is located in the case and supports and rotates the recording medium;
a head which processes information for the recording medium;
a head actuator which is provided in the case, supports the head for movement, and moves the head with respect to the recording medium;
a control circuit board overlapped on an outer surface of the case;
a first connector mounted on the control circuit board; and
a second connector connected to the first connector and the drive motor,
the case having a storage recess which opens in the outer surface of the case, projects into the case, and houses the first and second connectors.

11. The disk device according to claim 10, wherein the storage recess is defined in a corner portion of the case.
